(19) United States
(12) Patent Application Publication
(10) Pub. No.: US 2026/0202776 A1
(43) Pub. Date: Jul. 16, 2026

(54) TONER CARTRIDGE

(71) Applicant: GENERAL PLASTIC INDUSTRIAL CO., LTD., Taichung City (TW)

(72) Inventor: Yueh-Chun LEE, Taichung City (TW)

(73) Assignee: GENERAL PLASTIC INDUSTRIAL CO., LTD., Taichung City (TW)

(21) Appl. No.: 19/416,530

(22) Filed: Dec. 11, 2025

(30) Foreign Application Priority Data
Jan. 13, 2025 (TW) 114101362

(51) Int. Cl. G03G 15/08

(52) U.S. Cl. CPC G03G 15/0886; G03G 15/0868

(57) ABSTRACT

A toner cartridge includes a barrel body having an opening, a base mount having a covering portion provided with a toner outlet and an abutting portion, a sliding seat having a main body slidably movable between first and second positions and provided with a through groove and a first through hole, and a swingable member having a pivoting portion pivotally connected with the sliding seat, an abutment portion to be pushed by the abutting portion, and a push door having a second through hole. When the sliding seat moves to the second position, the swingable member is rotated by the abutting portion such that the toner outlet, and the first and second through holes communicate with one another. Thus, when the toner cartridge is assembled into an image-forming apparatus, the toner outlet is opened to communicate with a toner inlet of the apparatus while preventing toner leakage during assembly.

### BACKGROUND OF THE INVENTION

### Field of the Invention

The present invention relates generally to electronic image-forming apparatus and more particularly, to a toner cartridge having a toner outlet positioning mechanism.

### Description of the Related Art

General electronic image-forming apparatus, such as copiers or multifunctional printers, are equipped with toner cartridges. When storing or transporting a toner cartridge, its toner outlet must be sealed. When the toner cartridge is installed in an electronic image-forming apparatus, the toner outlet of the toner cartridge must be aligned and communicated with a toner inlet of the electronic image-forming apparatus so that toner can be delivered into the apparatus. Since the structures of toner inlets differ among various models of electronic image-forming apparatus, toner cartridges must be specifically designed to match the corresponding apparatus, in order to reliably deliver toner from the toner cartridge into the electronic image-forming apparatus.

### SUMMARY OF THE INVENTION

The present invention has been accomplished in view of the above-noted circumstances. It is an objective of the present invention to provide a toner cartridge that, when assembled into and positioned within an electronic image-forming apparatus, can open its originally sealed toner outlet and allow the toner outlet to communicate with a toner inlet of the electronic image-forming apparatus so that toner can be delivered into the apparatus, while preventing toner leakage during the assembly process.

To achieve the foregoing objective, the toner cartridge provided by the present invention comprises a barrel body, a base mount, a sliding seat, and a swingable member. The barrel body has an opening at one end thereof. The base mount comprises a covering portion covering the opening, a toner outlet disposed on the covering portion, and at least one abutting portion disposed on an outer wall of the covering portion. The sliding seat comprises a main body slidably disposed with the base mount, a through groove formed in the main body, and a first through hole formed in the main body. The main body is movable from a first position toward the barrel body to a second position. The swingable member comprises a pivoting portion pivotally connected with the sliding seat, an abutment portion extending from the pivoting portion in one direction and configured to be pushed by the abutting portion of the base mount, a push door extending from the pivoting portion in another direction, and a second through hole disposed on the push door. When the sliding seat moves from the first position to the second position, the swingable member is rotated by being pushed by the abutting portion, such that the push door synchronously rotates and passes downward through the through groove; and when the sliding seat is located at the second position, the toner outlet, the first through hole, and the second through hole are in communication with one another. Accordingly, when the toner cartridge is assembled into and positioned within an electronic image-forming apparatus, the originally sealed toner outlet can be opened and allowed to communicate with a toner inlet of the electronic image-forming apparatus to deliver toner into the apparatus, while preventing toner leakage during the assembly process.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a toner cartridge according to a preferred embodiment of the present invention;

FIG. 2 is an exploded view of the toner cartridge according to the preferred embodiment of the present invention;

FIG. 3 is a perspective view of a part of the toner cartridge according to the preferred embodiment of the present invention;

FIG. 4 is an exploded view of a part of the toner cartridge according to the preferred embodiment of the present invention; and

FIGS. 5 to 12 are schematic views illustrating the operation of the toner cartridge according to the preferred embodiment of the present invention.

### DETAILED DESCRIPTION OF THE INVENTION

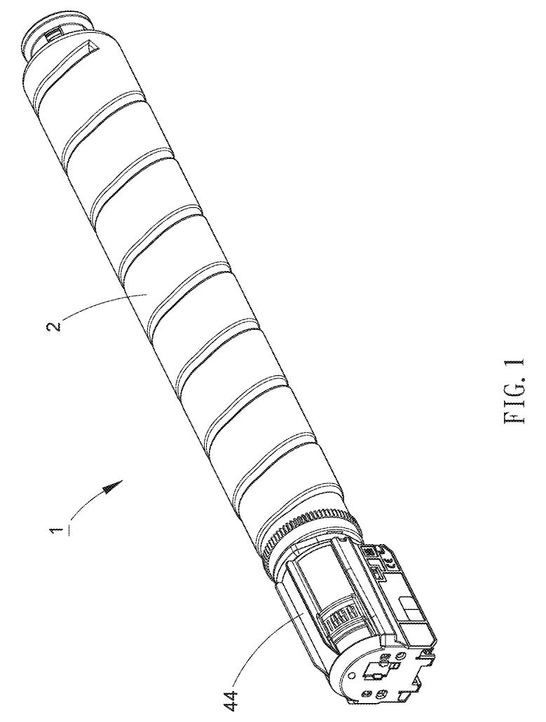

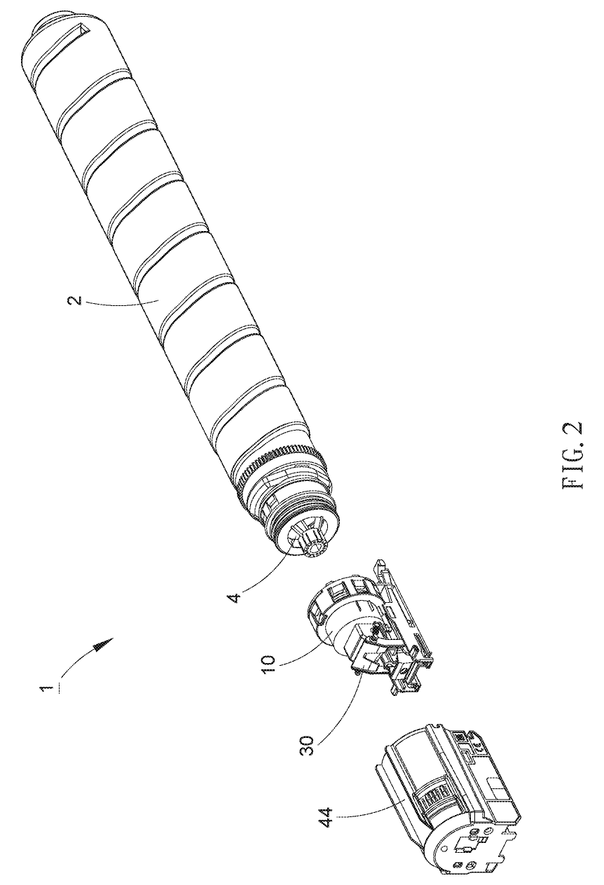

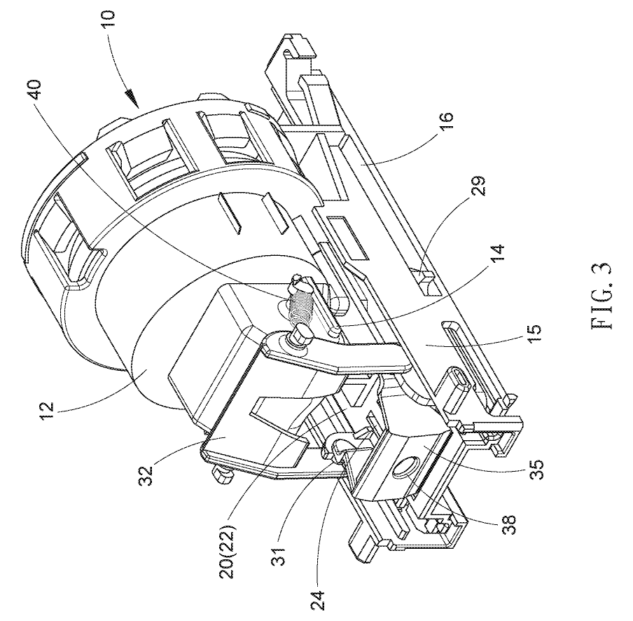

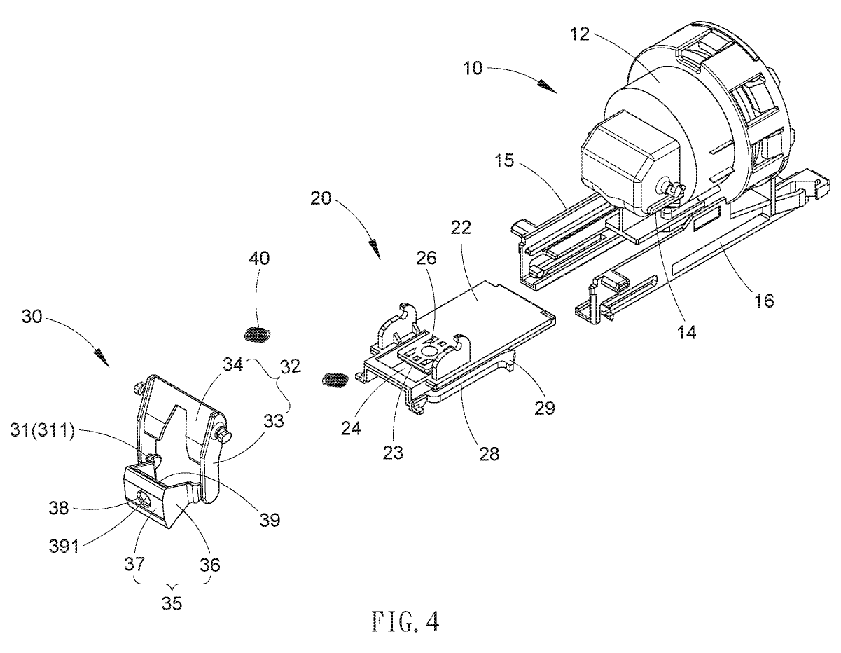

Hereunder one embodiment will be detailedly described with accompanying drawings for illustrating technical features and structure of the present invention. As shown in FIGS. 1-4 and 6, a toner cartridge 1 provided according to a preferred embodiment of the present invention comprises a barrel body 2, a base mount 10, a sliding seat 20, a swingable member 30, two elastic members 40, and a cover member 44.

The barrel body 2 is cylindrical and configured to contain toner, and an opening 4 is formed at one end thereof.

The base mount 10 comprises a covering portion 12 coupled with the barrel body 2 to cover the opening 4, a toner outlet 13 disposed on a bottom side of the covering portion 12, two abutting portions 14 disposed on two lateral outer walls of the covering portion 12, a sliding portion 15 disposed below the covering portion 12, and two elongated grooves 16, namely two elongated cuts, located at left and right sides of the sliding portion 15. The covering portion 12 is shaped as a circular cap, and the toner outlet 13 communicates with the opening 4. Each abutting portion 14 has an elongated external appearance, although the shape is not limited. A first sealing member 18 is disposed at the bottom side of the base mount 10 corresponding to the position of the toner outlet 13, and the first sealing member 18 has a first central hole 19 corresponding to the toner outlet 13. The base mount 10 is made of a plastic material, although the material is not limited, and the first sealing member 18 is made of foam sponge.

The sliding seat 20 comprises a main body 22 slidably disposed back and forth with the sliding portion 15 of the base mount 10, a U-shaped through groove 24 formed in the main body 22, a first through hole 26 formed in the main body 22, and two elastic arms 28 extending respectively from left and right sides of the main body 22. Each elastic arm 28 has a hook 29 extending outward from its distal end, and the two hooks 29 pass through the two elongated grooves 16 of the base mount 10. The main body 22 is movable from a first position P1 toward the barrel body 2 to a second position P2. A bottom side of the main body 22 is provided with an arcuate portion 23 located around the first through hole 26, and the arcuate portion 23 has an arcuate surface. The sliding seat 20 is made of a plastic material, although the material is not limited.

The swingable member 30 comprises a pivoting portion 31 pivotally connected with the sliding seat 20, an abutment portion 32 extending upward from the pivoting portion 31 and configured to be pushed by the abutting portions 14 of the base mount 10, a push door 35 extending forward from the pivoting portion 31, and a second through hole 38 formed in the push door 35. The pivoting portion 31 has two pivots 311. The abutment portion 32 includes two first arms 33 extending upward from the two pivots 311, and a first bridge 34 connecting the two first arms 33. The two first arms 33 are configured to be pushed by the two abutting portions 14. The push door 35 includes two second arms 36 extending forward from the two pivots 311, and a second bridge 37 connecting the two second arms 36, and the second through hole 38 is formed in the second bridge 37. A second sealing member 39 is disposed on the second bridge 37, and the second sealing member 39 has a second central hole 391 corresponding to the second through hole 38. The swingable member 30 is made of a plastic material, although the material is not limited, and the second sealing member 39 is made of foam sponge.

The two elastic members 40 each have two ends respectively disposed with the covering portion 12 of the base mount 10 and the abutment portion 32 of the swingable member 30, such that the motion of the swingable member 30 can be made more reliable. In this embodiment, the elastic members 40 are tension springs, although other equivalent components may be used.

The cover member 44 is engaged with the base mount 10. On one hand, it protects the internal components; on the other hand, it reinforces the structure of the base mount 10, particularly the sliding portion 15.

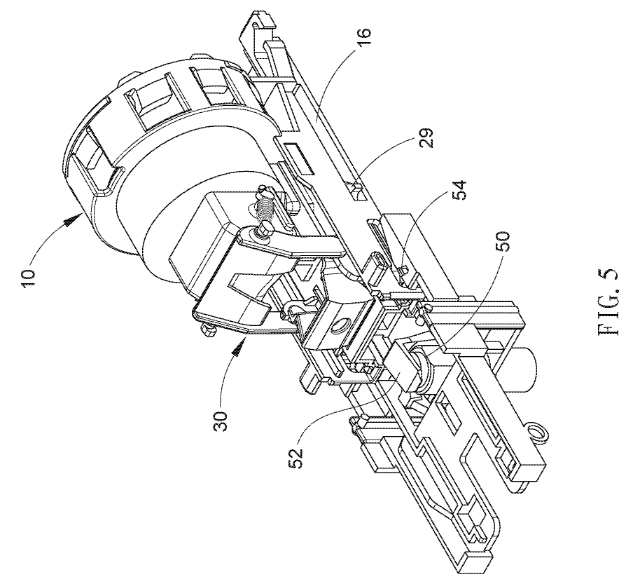

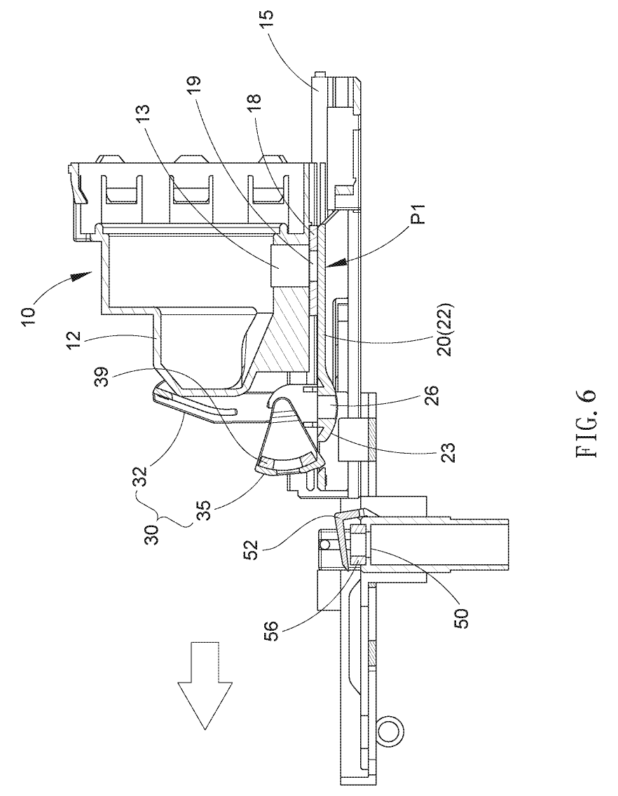

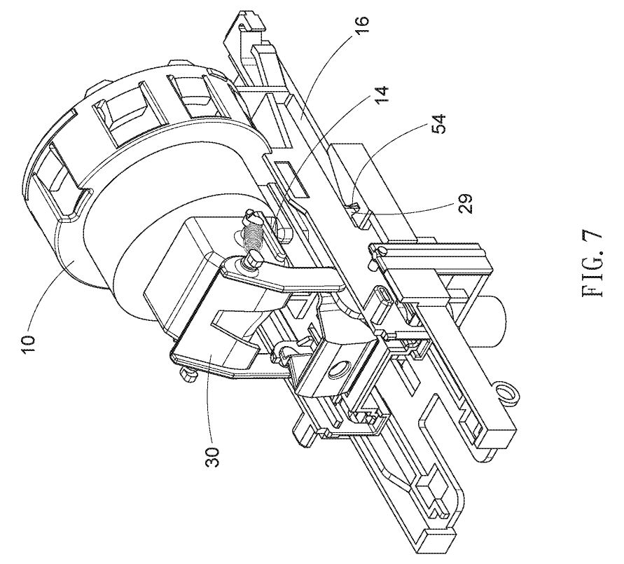

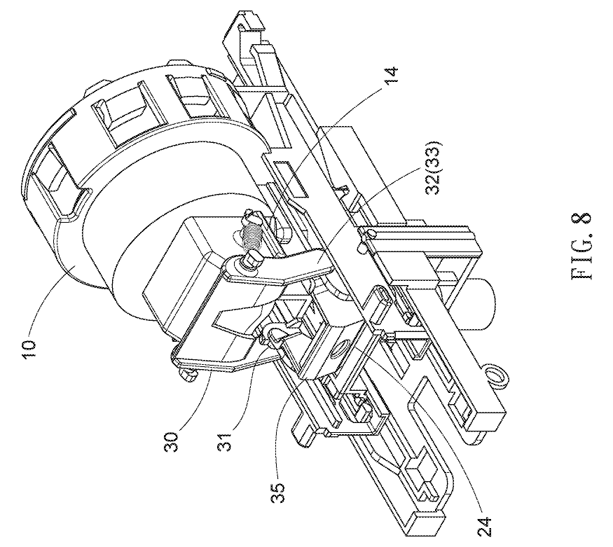

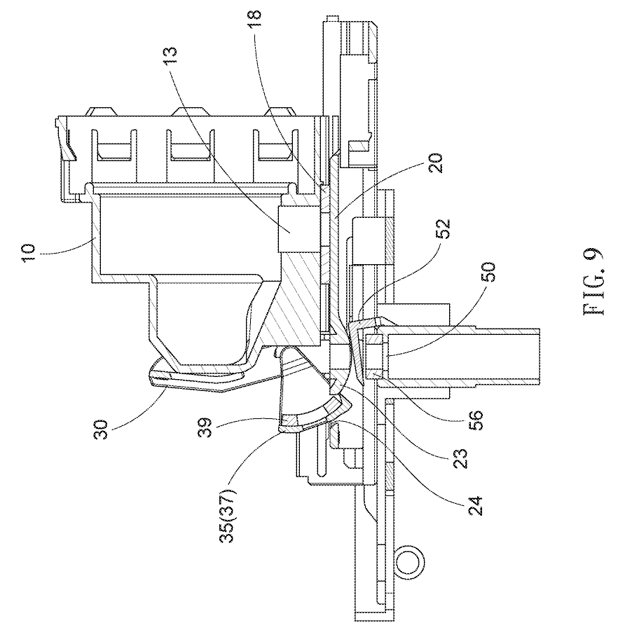

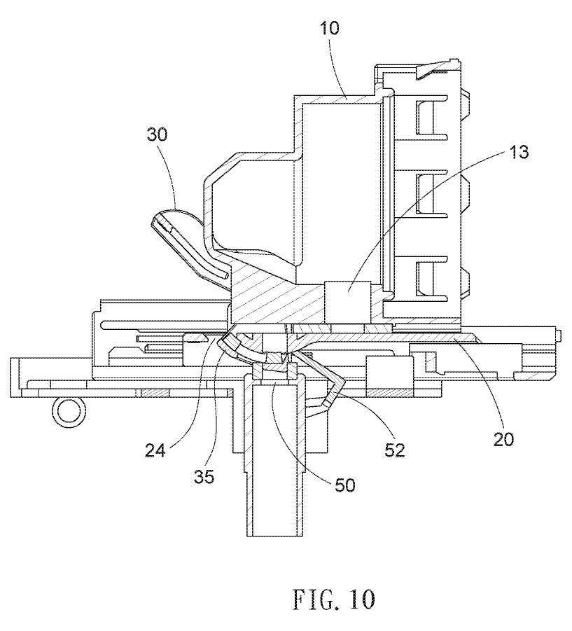

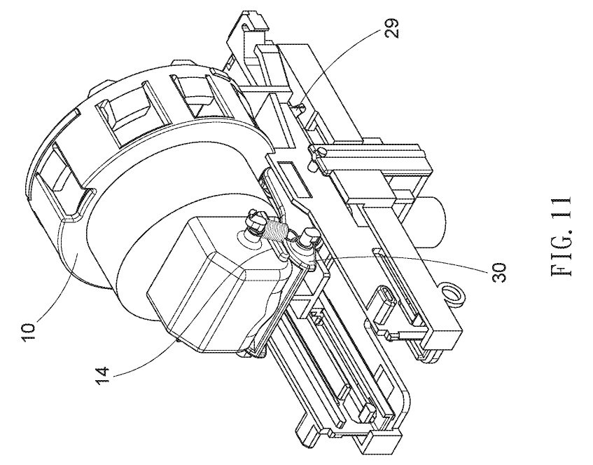

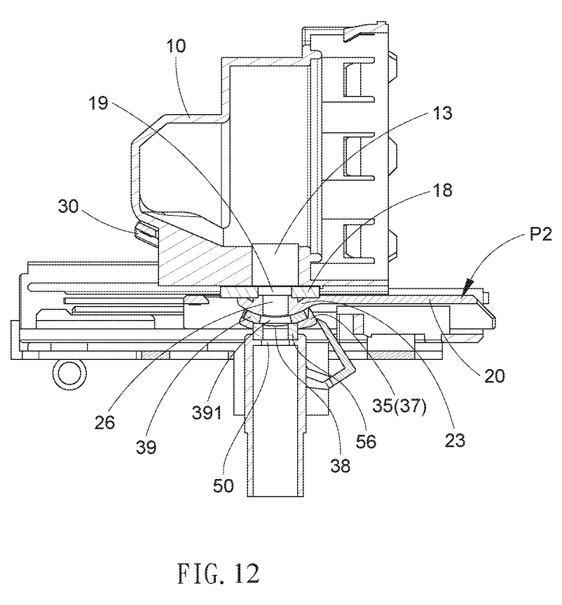

When the toner cartridge 1 is assembled into an electronic image-forming apparatus, the toner outlet 13 must be in alignment and communication with a toner inlet 50 so that toner can be delivered into the electronic image-forming apparatus. As shown in FIGS. 5-6, the toner outlet 13 is originally sealed by the main body 22 of the sliding seat 20 located at the first position P1. A swingable sealing door 52 is disposed beside the toner inlet 50 of the electronic image-forming apparatus to cover the toner inlet 50. During forward movement of the toner cartridge 1 (i.e., toward the left in FIG. 6), the hooks 29 protruding over the elongated grooves 16 first engage recessed portions 54 of the electronic image-forming apparatus, as shown in FIG. 7, preventing the sliding seat 20 and the swingable member 30 from moving forward together with the barrel body 2 and the base mount 10. As the base mount 10 continues to move forward, the abutting portions 14 push the abutment portion 32 of the swingable member 30, causing the swingable member 30 to rotate about the pivoting portion 31 and causing the push door 35 to synchronously rotate and pass downward through the through groove 24, as shown in FIGS. 8 and 9. As the base mount 10 advances further, the abutting portions 14 continue to push the swingable member 30, causing the push door 35 to rotate further and push open the sealing door 52 to open the toner inlet 50, as illustrated in FIG. 10. Finally, as shown in FIGS. 11-12, when the toner cartridge 1 advances to its final positioned state, the sliding seat 20 moves relative to the base mount 10 to the second position P2, and the toner outlet 13, the first through hole 26, the second through hole 38, and the toner inlet 50 are arranged from top to bottom with their positions aligned and communicating with one another. With the first sealing member 18 disposed between the base mount 10 and the sliding seat 20, the second sealing member 39 disposed between the arcuate portion 23 of the sliding seat 20 and the second bridge 37 of the push door 35 of the swingable member 30, and a third sealing member 56 disposed above the toner inlet 50 abutting the second bridge 37, a sealed passage is formed. This allows toner in the toner cartridge 1 to be smoothly delivered into the electronic image-forming apparatus while preventing toner leakage during assembly, thereby achieving the objectives of the present invention.

Based on the design concept of the present invention, various modifications to the toner cartridge 1 may be made. For example, the elastic members 40 may be omitted, or the structures of the sliding seat 20 and the swingable member 30 may be altered. Any such variations that can be easily conceived should fall within the scope of the claims of the present invention.

What is claimed is:

1. A toner cartridge, comprising:
a barrel body having an opening at one end thereof,
a base mount comprising a covering portion covering the opening, a toner outlet
disposed on the covering portion, and at least one abutting portion disposed on an outer wall of the covering portion;a sliding seat comprising a main body slidably disposed with the base mount, a through groove formed in the main body, and a first through hole formed in the main body, the main body being movable from a first position toward the barrel body to a
second position; anda swingable member comprising a pivoting portion pivotally connected with the sliding seat, an abutment portion extending from the pivoting portion in one direction and configured to be pushed by the abutting portion of the base mount, a push door extending from the pivoting portion in another direction, and a second through hole
disposed on the push door;wherein, when the sliding seat moves from the first position to the second position, the swingable member is rotated by being pushed by the abutting portion, such that the push door synchronously rotates and passes downward through the through groove, and when the sliding seat is located at the second position, the toner outlet, the
first through hole, and the second through hole are in communication with one another.

2. The toner cartridge of claim 1, further comprising at least one elastic member having two ends respectively disposed with the covering portion of the base mount and the abutment portion of the swingable member.

3. The toner cartridge of claim 1, wherein the sliding seat further comprises two elastic arms extending from the main body; each of the two elastic arms is provided with a hook; the base mount further comprises two elongated grooves through which the hooks of the two elastic arms pass, respectively.

4. The toner cartridge of claim 1, wherein the abutment portion of the swingable member comprises two first arms extending from the pivoting portion, and a first bridge connecting the two first arms; the first arms are configured to be pushed by the abutting portion.

5. The toner cartridge of claim 1, wherein the push door of the swingable member comprises two second arms extending from the pivoting portion, and a second bridge connecting the two second arms; the second through hole is disposed on the second bridge.

6. The toner cartridge of claim 5, wherein the through groove of the sliding seat is U-shaped.

7. The toner cartridge of claim 5, further comprising a second sealing member
disposed on the second bridge; wherein the second sealing member has a second central hole corresponding to the second through hole.

8. The toner cartridge of claim 1, wherein the main body of the sliding seat has an arcuate portion located around the first through hole.

9. The toner cartridge of claim 1, further comprising a first sealing member disposed with the base mount and abutting against the sliding seat; wherein the first sealing member has a first central hole corresponding to the toner outlet.

10. The toner cartridge of claim 1, further comprising a cover member engaged with the base mount.

11. The toner cartridge of claim 1, wherein, when the sliding seat is located at the second position, the toner outlet, the first through hole, and the second through hole
are arranged from top to bottom.
